(19) United States
(12) Patent Application Publication
(10) Pub. No.: US 2016/0371884 A1
(43) Pub. Date: Dec. 22, 2016

(54) COMPLEMENTARY AUGMENTED REALITY

(71) Applicant: Microsoft Technology Licensing, LLC, Redmond, WA (US)

(72) Inventors: Hrvoje BENKO, Seattle, WA (US); Andrew D. WILSON, Seattle, WA (US); Eyal OFEK, Redmond, WA (US); Feng ZHENG, Chapel Hill, NC (US)

(73) Assignee: Microsoft Technology Licensing, LLC, Redmond, WA (US)

(21) Appl. No.: 14/742,458

(22) Filed: Jun. 17, 2015

(51) Int. Cl. G06T 19/00; H04N 5/232

(52) U.S. Cl. CPC G06T 19/006; H04N 5/23229

(57) ABSTRACT

The described implementations relate to complementary augmented reality. One implementation is manifest as a system including a projector that can project a base image from an ancillary viewpoint into an environment. The system also includes a camera that can provide spatial mapping data for the environment and a display device that can display a complementary three-dimensional (3D) image to a user in the environment. In this example, the system can generate the complementary 3D image based on the spatial mapping data and the base image so that the complementary 3D image augments the base image and is dependent on a perspective of the user. The system can also update the complementary 3D image as the perspective of the user in the environment changes.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1-9 show example complementary augmented reality scenarios in accordance with some implementations.

FIGS. 10-11 show example computing systems that can be configured to accomplish certain concepts in accordance with some implementations.

FIGS. 12-14 are flowcharts for accomplishing certain concepts in accordance with some implementations.

### DETAILED DESCRIPTION

This discussion relates to complementary augmented reality. An augmented reality experience can include both real world and computer-generated content. For example, head-mounted displays (HMDs) (e.g., HMD devices), such as optically see-through (OST) augmented reality glasses (e.g., OST displays), are capable of overlaying computer-generated spatially-registered content onto a real world scene. However, current optical designs and weight considerations can limit a field of view (FOV) of HMD devices to around a 40 degree angle, for example. In contrast, an overall human vision FOV can be close to a 180 degree angle in the real world. In some cases, the relatively limited FOV of current HMD devices can detract from a user's sense of immersion in the augmented reality experience. The user's sense of immersion can contribute to how realistic the augmented reality experience seems to the user. In the disclosed implementations complementary augmented reality concepts can be implemented to improve a sense of immersion of a user in an augmented reality scenario. Increasing the user's sense of immersion can improve the overall enjoyment and success of the augmented reality experience.

In some implementations, multiple forms of complementary computer-generated content can be layered onto a real world scene. For example, the complementary content can include three-dimensional (3D) images (e.g., visualizations, projections). In another example, the complementary content can be spatially registered in the real world scene. Furthermore, in some implementations, the complementary content can be rendered from different perspectives. Different instances of the complementary computer-generated content can enhance each other. The complementary computer-generated content can extend a FOV, change the appearance of the real world scene (e.g., a room), mask objects in the real world scene, induce apparent motion, and/or display both public and private content, among other capabilities. As such, complementary augmented reality can enable new gaming, demonstration, instructional, and/or other viewing experiences.

### Example Complementary Augmented Reality Scenarios

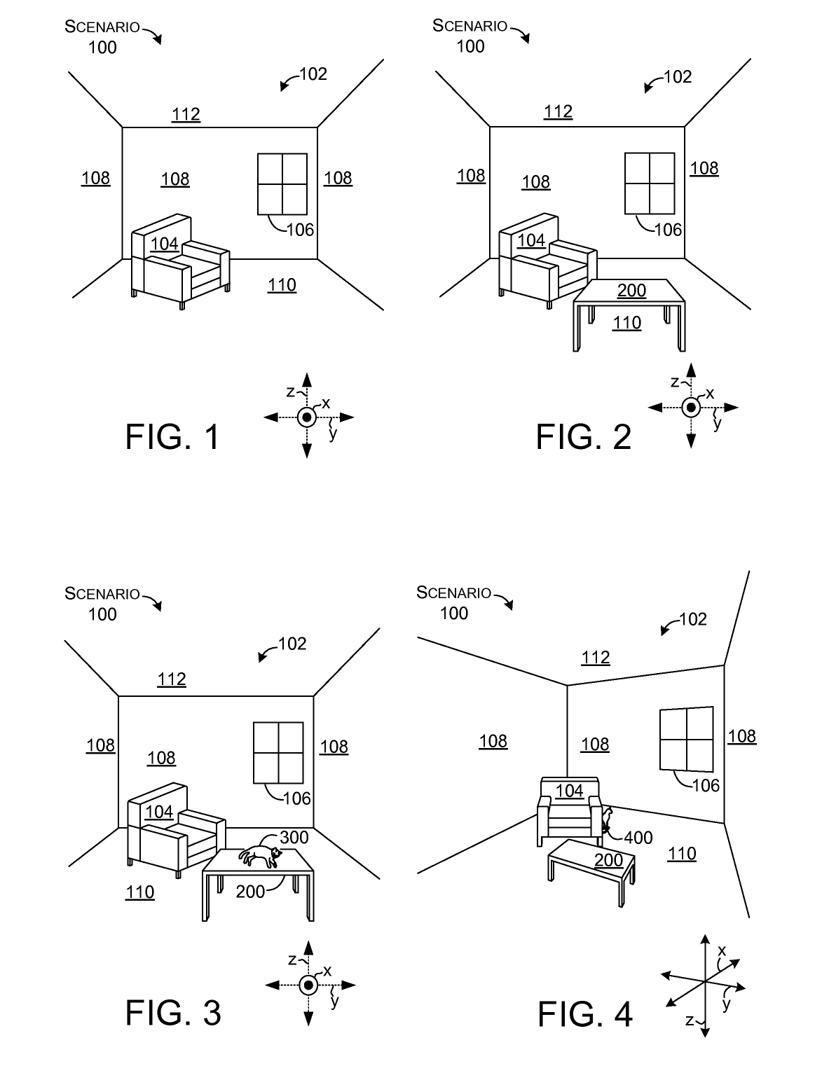

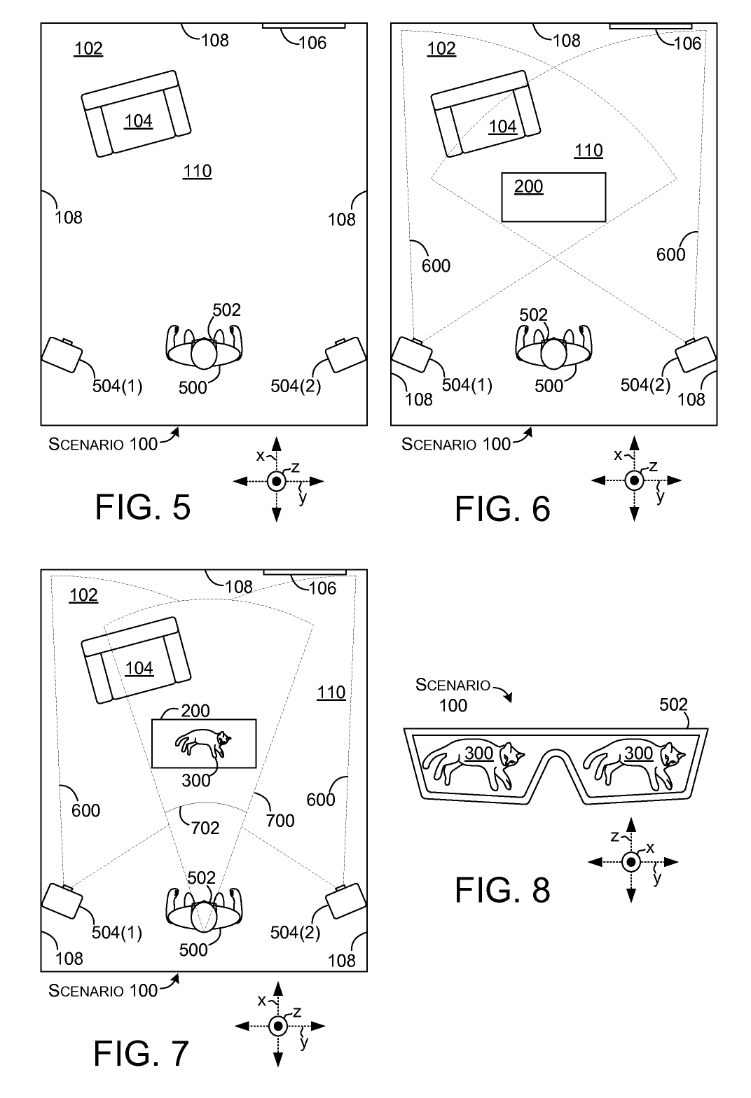

FIGS. 1-9 collectively illustrate an example complementary augmented reality scenario 100. In general, FIGS. 1-7 and 9 show a real world scene 102 (e.g., a view inside a room, an environment). For discussion purposes, consider that a user is standing in the real world scene (shown relative to FIGS. 5-7 and 9). FIGS. 1-4 can be considered views from a perspective of the user. FIGS. 5-7 and 9 can be considered overhead views of complementary augmented reality scenario 100 that correspond to the views from the perspective of the user. Instances of corresponding views will be described as they are introduced below.

Referring to FIG. 1, the perspective of the user in real world scene 102 generally aligns with the x-axis of the x-y-z reference axes. Several real world elements are visible within real world scene 102, including a chair 104, a window 106, walls 108, a floor 110, and a ceiling 112. In this example, the chair, window, walls, floor, and ceiling are real world elements, not computer-generated content. Complementary augmented reality scenario 100 can be created within the real world scene shown in FIG. 1, as described below.

FIG. 2 shows addition of a table image 200 to scenario 100. The table image can be computer-generated content as opposed to a real world element. In this example scenario, the table image is a 3D projection of computer-generated content. In some implementations, the table image can be spatially registered within the real world scene 102. In other words, the table image can be a correct scale for the room and projected such that it appears to rest on the floor 110 of the real world scene at a correct height. Also, the table image can be rendered such that the table image does not overlap with the chair 104. Since the table image is a projection in this case, the table image can be seen by the user and may also be visible to other people in the room.

FIG. 3 shows addition of a cat image 300 to scenario 100. The cat image can be computer-generated content as opposed to a real world element. In this example scenario, the cat image is a 3D visualization of computer-generated content. The cat image can be an example of complementary content intended for the user, but not for other people that may be in the room. For example, special equipment may be used by the user to view the cat image. For instance, the user may have an HMD device that allows the user to view the cat image (described below relative to FIGS. 5-9). Stated another way, in some cases the cat image may be visible to a certain user, but may not be visible to other people in the room.

In some implementations, table image 200 can be considered a base image and cat image 300 can be considered a complementary image. The complementary image can overlap and augment the base image. In this example, the complementary image is a 3D image and the base image is also a 3D image. In some cases, the base and/or complimentary images can be two-dimensional (2D) images. The designation of “base” and/or “complementary” is not meant to be limiting; any of a number of images could be base images and/or complementary images. For example, in some cases the cat could be the base image and the table could be the complementary image. Stated another way, the table image and the cat image are complementary to one another. In general, the combination of the complementary table and cat images can increase a sense of immersion for a person in augmented reality scenario 100, contributing to how realistic the augmented reality scenario feels to the user.

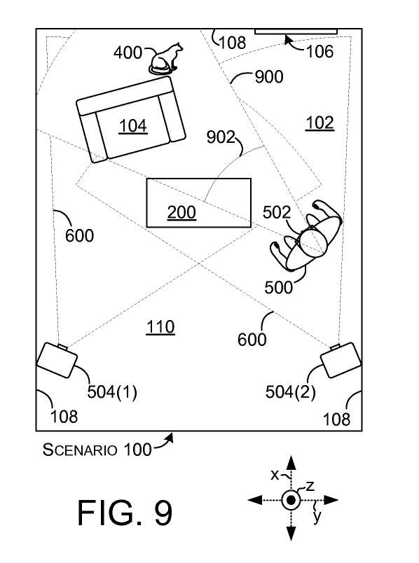

FIG. 4 shows a view of real world scene 102 from a different perspective. For discussion purposes, consider that the user has moved to a different position in the room and is viewing the room from the different perspective (described below relative to FIG. 9). Stated another way, in FIG. 4 the different perspective does not generally align with the x-axis of the x-y-z reference axes. The real world elements, including the chair 104, window 106, walls 108, floor 110, and ceiling 112, are visible from the different perspective. In this example, the table image 200 is also visible from the different perspective. In FIG. 4, cat image 300 has changed to cat image 400. In this case, the change in the cat image is for illustration purposes and not dependent on or resultant from the change in the user perspective. Cat image 400 can be considered an updated cat image since the “cat” is shown at a different location in the room. In this case, the table and cat images are still spatially registered, including appropriate scale and appropriate placement within the real world scene. Further discussion of this view and the different perspective will be provided relative to FIG. 9.

FIG. 5 is an overhead view of the example complementary augmented reality scenario 100. FIG. 5 can be considered analogous to FIG. 1, although FIG. 5 is illustrated from a different view than FIG. 1. In this case, the view of real world scene 102 is generally aligned with the z-axis of the x-y-z reference axes. FIG. 5 only shows real world elements, similar to FIG. 1. FIG. 5 includes the chair 104, window 106, walls 108, and floor 110 that were introduced in FIG. 1. FIG. 5 also includes a user 500 wearing HMD device 502. The HMD device can have an OST near-eye display, which will be discussed relative to FIG. 8. FIG. 5 also includes projectors 504(1) and 504(2). Different instances of drawing elements are distinguished by parenthetical references, e.g., 504(1) refers to a different projector than 504(2). When referring to multiple drawing elements collectively, the parenthetical will not be used, e.g., projectors 504 can refer to either or both of projector 504(1) or projector 504(2). The number of projectors shown in FIG. 5 is not meant to be limiting, one or more projectors could be used.

FIG. 6 can be considered an overhead view of, but otherwise analogous to, FIG. 2. As shown in FIG. 6, the projectors 504(1) and 504(2) can project the table image 200 into the real world scene 102. Projection by the projectors is generally indicated by dashed lines 600. In some cases, the projection indication by dashed lines 600 can also generally be considered viewpoints of the projectors (e.g., ancillary viewpoints). In this case, the projections by projectors 504 are shown as “tiling” within real world scene 102. For example, the projections cover differing areas of the real world scene. Covering different areas may or may not include overlapping of the projections. Stated another way, multiple projections may be used for greater coverage and/or increased FOV in a complementary augmented reality experience. As such, the complementary augmented reality experience may feel more immersive to the user.

FIG. 7 can be considered an overhead view of, but otherwise analogous to, FIG. 3. As shown in FIG. 7, the cat image 300 can be made visible to user 500. In this case, the cat image is displayed to the user in the HMD device 502. However, while the cat image is shown in FIG. 7 for illustration purposes, in this example it would not be visible to another person in the room. In this case the cat image is only visible to the user via the HMD device.

In the example in FIG. 7, a view (e.g., perspective) of user 500 is generally indicated by dashed lines 700. Stated another way, dashed lines 700 can generally indicate a pose of HMD device 502. While projectors 504(1) and 504(2) are both projecting table image 200 in the illustration in FIG. 7, dashed lines 600 (see FIG. 6) are truncated where they intersect dashed lines 700 to avoid clutter on the drawing page. The truncation of dashed lines 600 is not meant to indicate that the projection ends at dashed lines 700. The truncation of dashed lines 600 is also not meant to indicate that the projection is necessarily “underneath” and/or superseded by views within the HMD device in any way.

In some implementations, complementary augmented reality concepts can expand (e.g., increase, widen) a FOV of a user. In the example shown in FIG. 7, a FOV of user 500 within HMD device 502 is generally indicated by angle 702. For instance, angle 702 can be less than 100 degrees (e.g., relatively narrow), such as in a range between 30 and 70 degrees, as measured in the y-direction of the x-y-z reference axes. As shown in the example in FIG. 7, the FOV may be approximately 40 degrees. In this example, projectors 504 can expand the FOV of the user. For instance, complementary content could be projected by the projectors into the area within dashed lines 600, but outside of dashed lines 700 (not shown). Stated another way, complementary content could be projected outside of angle 702, thereby expanding the FOV of the user with respect to the complementary augmented reality experience. This concept will be described further relative to FIG. 9. Furthermore, while the FOV has been described relative to the y-direction of the x-y-z reference axes, the FOV may also be measured in the z-direction (not shown). Complementary augmented reality concepts can also expand the FOV of the user in the z-direction.

FIG. 8 is a simplified illustration of cat image 300 as seen by user 500 within HMD device 502. Stated another way, FIG. 8 is an illustration of the inside of the OST near-eye display of the HMD device. In the example shown in FIG. 8, two instances of the cat image are visible within the HMD device. In this example, the two instances of the cat image represent stereo views (e.g., stereo images, stereoscopic views) of the cat image. In some cases, one of the stereo views can be intended for the left eye and the other stereo view can be intended for the right eye of the user. The two stereo views as shown in FIG. 8 can collectively create a single 3D view of the cat image for the user, as illustrated in the examples in FIGS. 3 and 7.

FIG. 9 can be considered an overhead view of, but otherwise analogous to, FIG. 4. In FIG. 9, user 500 has moved to a different position relative to FIG. 7. Also, cat image 400 has replaced cat image 300, similar to FIG. 4. Because the user has moved to a different position, the user has a different (e.g., changed, updated) perspective, which is generally indicated by dashed lines 900. In this example, cat image 400 would appear to the user to be partially behind chair 104 (as shown in FIG. 4).

FIG. 9 also includes dashed lines 600, indicating projection by (e.g., ancillary viewpoints of) the projectors 504. In this example, dashed lines 600 are truncated where they intersect dashed lines 900 to avoid clutter on the drawing page (similar to the example in FIG. 7). In FIG. 9, a FOV of user 500 within HMD device 502 is generally indicated by angle 902, which can be approximately 40 degrees (similar to the example in FIG. 7). As illustrated in FIG. 9, an overall FOV of the user can be expanded using complementary augmented reality concepts. For example, the projection area of the projectors, indicated by dashed lines 600, provides a larger overall FOV (e.g., >100 degrees, >120 degrees, >140 degrees, or >160 degrees) for the user than the view within the HMD device alone. For instance, part of table image 200 falls outside of dashed lines 900 (and angle 902), but within dashed lines 600. Thus, complementary augmented reality concepts can be considered to have expanded the FOV of the user beyond angle 902. For instance, a portion of the table image can appear outside of the FOV of the HMD device and can be presented by the projectors.

Referring again to FIG. 6, table image 200 can be projected simultaneously by both projectors 504(1) and 504(2). In some cases, the different projectors can project the same aspects of the table image. In other cases, the different projectors can project different aspects of the table image. For instance, projector 504(1) may project legs and a tabletop of the table image (not designated). In this instance, projector 504(2) may project shadows and/or highlights of the table image, and/or other elements that increase a sense of realism of the appearance of the table image to user 500.

Referring to FIGS. 7 and 8, cat image 300 can be seen by user 500 in HMD device 502. As noted above, the cat image can be an example of computer-generated content intended for private viewing by the user. In other cases, the cat image can be seen by another person, such as another person with another HMD device. In FIG. 8, only the cat image is illustrated as visible in the HMD device due to limitations of the drawing page. In other examples, the HMD device may display additional computer-generated content. For example, the HMD device may display additional content that is complementary to other computer-generated or real-world elements of the room. For instance, the additional content could include finer detail, shading, shadowing, color enhancement/correction, and/or highlighting of table image 200, among other content. Stated another way, the HMD device can provide complementary content that improves an overall sense of realism experienced by the user in complementary augmented reality scenario 100.

Referring again to FIG. 9, real world scene 102 can be seen from a different perspective by user 500 when the user moves to a different position. In the example shown in FIG. 9, the user has moved to a position that is generally between projector 504(2) and table image 200. As such, the user may be blocking part of the projection of the table image by projector 504(2). In order to maintain a sense of realism and/or immersion of the user in complementary augmented reality scenario 100, any blocked projection of the table image can be augmented (e.g., filled in) by projector 504(1) and/or HMD device 502. For example, the HMD device may display a portion of the table image to the user. In this example, the projector 504(2) can also stop projecting the portion of the table image that might be blocked by the user so that the projection does not appear on the user (e.g., projected onto the user's back). Stated another way, complementary content can be updated as the perspective and/or position of the user changes.

Additionally and/or alternatively, user 500 may move to a position where he/she would be able to view a backside of table image 200. For example, the user may move to a position between the table image and window 106 (not shown). In this instance, neither projector 504(1) nor 504(2) may be able to render/project the table image for viewing by the user from such a user perspective. In some implementations, complementary augmented reality concepts can be used to fill in missing portions of computer-generated content to provide a seamless visual experience for the user. For example, depending on the perspective of the user, HMD device 502 can fill in missing portions of a window 106 side of the projected table image, among other views of the user. As such, some elements of complementary augmented reality can be considered view-dependent.

Furthermore, in some implementations, complementary augmented reality can enable improved multi-user experiences. In particular, the concept of view-dependency introduced above can be helpful in improving multi-user experiences. For example, multiple users in a complementary augmented reality scenario can have HMD devices (not shown). The HMD devices could provide personalized perspective views of view-dependent computer-generated content. Meanwhile, projectors and/or other devices could be tasked with displaying non-view dependent computer-generated content. In this manner the complementary augmented reality experiences of the multiple users could be connected (e.g., blended), such as through the non-view dependent computer-generated content and/or any real world elements that are present.

In some implementations, the example complementary augmented reality scenario 100 can be rendered in real-time. For example, the complementary content can be generated in anticipation of and/or in response to actions of user 500. The complementary content can also be generated in anticipation of and/or in response to other people or objects in the real world scene 102. For example, referring to FIG. 9, a person could walk behind chair 104 and toward window 106, passing through the location that cat image 400 is sitting. In anticipation, the cat image could move out of the way of the person.

Complementary augmented reality concepts can be viewed as improving a sense of immersion and/or realism of a user in an augmented reality scenario.

### Example Complementary Augmented Reality Systems

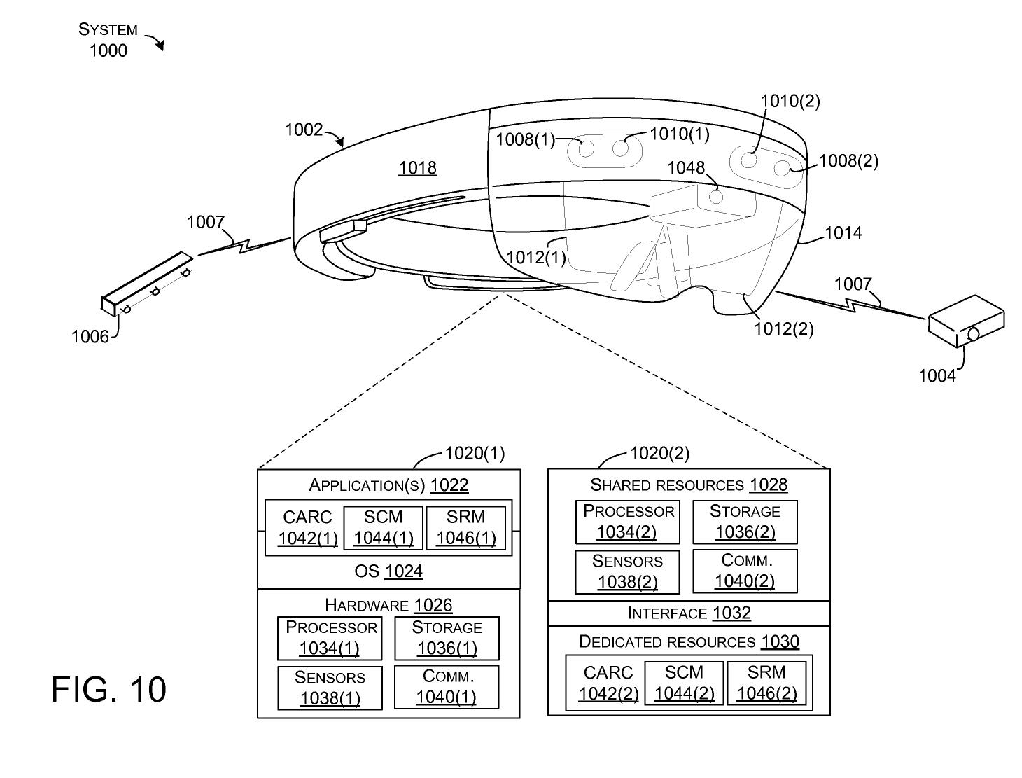

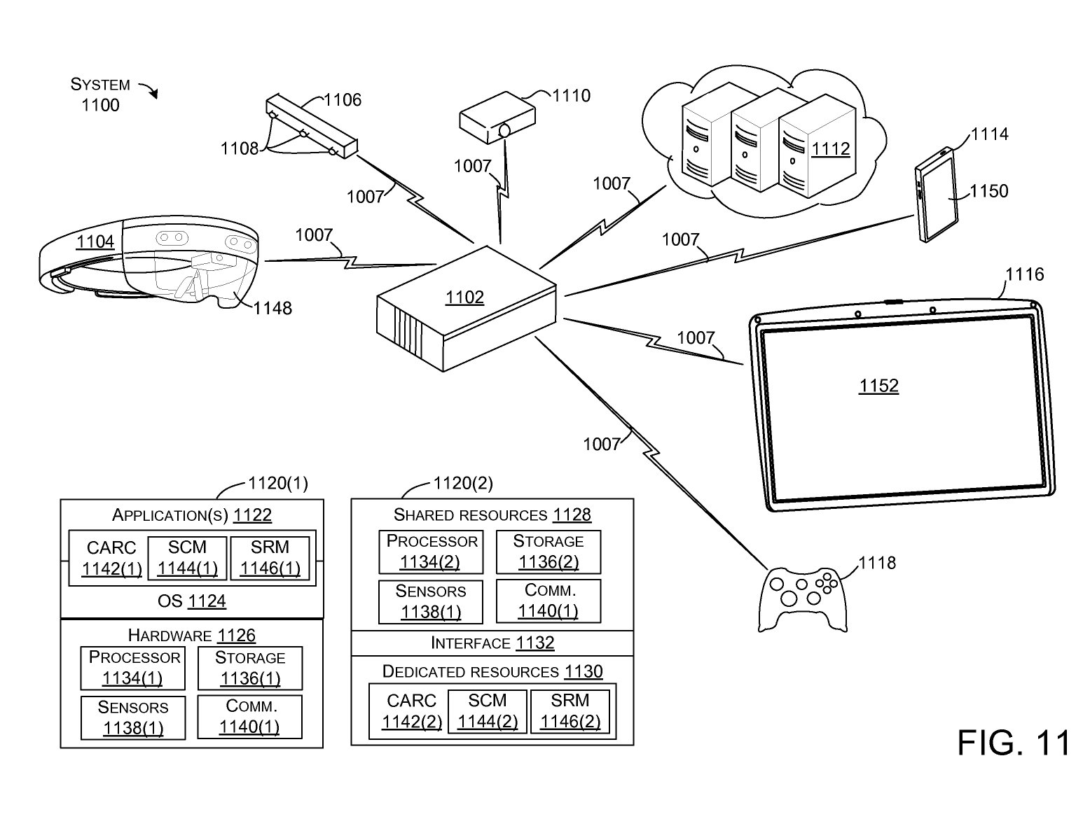

FIGS. 10 and 11 collectively illustrate example complementary augmented reality systems that are consistent with the disclosed implementations. FIG. 10 illustrates a first example complementary augmented reality system 1000. For purposes of explanation, system 1000 includes device 1002. In this case, device 1002 can be an example of a wearable device. More particularly, in the illustrated configuration, device 1002 is manifested as an HMD device, similar to HMD device 502 introduced above relative to FIG. 5. In other implementations, device 1002 could be designed to resemble more conventional vision-correcting eyeglasses, sunglasses, or any of a wide variety of other types of wearable devices.

As shown in FIG. 10, system 1000 can also include projector 1004 (similar to projector 504(1) and/or 504(2)) and camera 1006. In some cases, the projector and/or the camera can communicate with device 1002 via wired or wireless technologies, generally represented by lightning bolts 1007. In this case, device 1002 can be a personal device (e.g., belonging to a user), while the projector and/or the camera can be shared devices. In this example, device 1002, the projector, and the camera can operate cooperatively. Of course, in other implementations device 1002 could operate independently, as a stand-alone system. For instance, the projector and/or the camera could be integrated onto the HMD device, as will be discussed below.

As shown in FIG. 10, device 1002 can include outward-facing cameras 1008, inward-facing cameras 1010, lenses 1012 (corrective or non-corrective, clear or tinted), shield 1014, and/or headband 1018.

Two configurations 1020(1) and 1020(2) are illustrated for device 1002. Briefly, configuration 1020(1) represents an operating system centric configuration and configuration 1020(2) represents a system on a chip configuration. Configuration 1020(1) is organized into one or more applications 1022, operating system 1024, and hardware 1026. Configuration 1020(2) is organized into shared resources 1028, dedicated resources 1030, and an interface 1032 there between.

In either configuration, device 1002 can include a processor 1034, storage 1036, sensors 1038, a communication component 1040, and/or a complementary augmented reality component (CARC) 1042. In some implementations, the CARC can include a scene calibrating module (SCM) 1044, a scene rendering module (SRM) 1046, and/or other modules. These elements can be positioned in/on or otherwise associated with device 1002. For instance, the elements can be positioned within headband 1018. Sensors 1038 can include outwardly-facing camera(s) 1008 and/or inwardly-facing camera(s) 1010. In another example, the headband can include a battery (not shown). In addition, device 1002 can include a projector 1048. Examples of the design, arrangement, numbers, and/or types of components included on device 1002 shown in FIG. 10 and discussed above are not meant to be limiting.

From one perspective, device 1002 can be a computer. The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the computer. The storage can include any one or more of volatile or non-volatile memory, hard drives, flash storage devices, and/or optical storage devices (e.g., CDs, DVDs, etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and/or flash memory, among others.

As mentioned above, configuration 1020(2) can have a system on a chip (SOC) type design. In such a case, functionality provided by the device can be integrated on a single SOC or multiple coupled SOCs. One or more processors can be configured to coordinate with shared resources, such as memory, storage, etc., and/or one or more dedicated resources, such as hardware blocks configured to perform certain specific functionality. Thus, the term “processor” as used herein can also refer to central processing units (CPUs), graphical processing units (CPUs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

In some implementations, projector 1004 can project an image into an environment. For example, the projector can project a base image into the environment. For instance, referring to FIG. 6, the projector can be similar to projectors 504(1) and/or 504(2), which can project 3D table image 200 into real world scene 102. In some implementations, the projector can be a 3D projector, a wide-angle projector, an ultra-wide field of view projector, a 360 degree field of view projector, a body-worn projector, and/or a 2D projector, among others, and/or a combination of two or more different projectors. The projector can be positioned at a variety of different locations in an environment and/or with respect to a user. In some implementations, projector 1048 of device 1002 can project an image into the environment. One example of a projector with capabilities to accomplish at least some of the present concepts is Optoma GT760 DLP, 1280×800 (Optoma Technology).

In some implementations, complementary augmented reality system 1000 can collect data about an environment, such as real world scene 102 introduced relative to FIG. 1. Data about the environment can be collected by sensors 1038. For example, system 1000 can collect depth data, perform spatial mapping of an environment, determine a position of a user within an environment, obtain image data related to a projected and/or displayed image, and/or perform various image analysis techniques. In one implementation, projector 1048 of device 1002 can be a non-visible light pattern projector. In this case, outward-facing camera(s) 1008 and the non-visible light pattern projector can accomplish spatial mapping, among other techniques. For example, the non-visible light pattern projector can project a pattern or patterned image (e.g., structured light) that can aid system 1000 in differentiating objects generally in front of the user. The structured light can be projected in a non-visible portion of the radio frequency (RF) spectrum so that it is detectable by the outward-facing camera, but not by the user. For instance, referring to the example shown in FIG. 7, if user 500 looks toward chair 104, the projected pattern can make it easier for system 1000 to distinguish the chair from floor 110 or walls 108 by analyzing the images captured by the outwardly facing cameras. Alternatively or additionally to structured light techniques, the outwardly-facing cameras and/or other sensors can implement time-of-flight and/or other techniques to distinguish objects in the environment of the user. Examples of components with capabilities to accomplish at least some of the present concepts include Kinect™ (Microsoft Corporation) and OptiTrack Flex 3 (NaturalPoint, Inc.), among others.

In some implementations, device 1002 can receive information about the environment (e.g., environment data, sensor data) from other devices. For example, projector 1004 and/or camera 1006 in FIG. 10 can use similar techniques as described above for projector 1048 and outward-facing camera 1008 to collect spatial mapping data (e.g., depth data) and/or image analysis data for the environment. The environment data collected by projector 1004 and/or camera 1006 can be received by communication component 1040, such as via Bluetooth, Wi-Fi, or other technology. For instance, the communication component can be a Bluetooth compliant receiver that receives raw or compressed environment data from other devices. In some cases, device 1002 can be designed for system 1000 to more easily determine a position and/or orientation of a user of device 1002 in the environment. For example, device 1002 can be equipped with reflective material and/or shapes that can be more easily detected and/or tracked by camera 1006 of system 1000.

In some implementations, device 1002 can include the ability to track eyes of a user that is wearing device 1002 (e.g., eye tracking). These features can be accomplished by sensors 1038. In this example, the sensors can include the inwardly-facing cameras 1010. For example, one or more inwardly-facing cameras can point in at the user's eyes. Data (e.g., sensor data) that the inwardly-facing cameras provide can collectively indicate a center of one or both eyes of the user, a distance between the eyes, a position of device 1002 in front of the eye(s), and/or a direction that the eyes are pointing, among other indications. In some implementations, the direction that the eyes are pointing can be used to direct the outwardly-facing cameras 1008, such that the outwardly-facing cameras collect data from the environment specifically in the direction that the user is looking. Furthermore, device 1002 can be used to identify the user wearing device 1002. For instance, the inwardly facing cameras 1010 can obtain biometric information of the eyes that can be utilized to identify the user and/or distinguish users from one another. One example of a wearable device with capabilities to accomplish at least some of the present eye-tracking concepts is SMI Eye Tracking Glasses 2 Wireless (SensoMotoric Instruments, Inc.).

In some implementations, device 1002 can display an image to a user wearing device 1002. For example, device 1002 can use information about the environment to generate complementary augmented reality images and display the images to the user. Compilation of information about the environment and generation of complementary augmented reality images will be described further below. Examples of wearable devices with capabilities to accomplish at least some of the present display concepts include Lumus DK-32 1280×720 (Lumus Ltd.) and HoloLens™ (Microsoft Corporation), among others.

While distinct sensors in the form of cameras 1008 and 1010 are illustrated in FIG. 10, sensors 1038 may also be integrated into device 1002, such as into lenses 1012 and/or headband 1018, as noted above. In a further implementation (not shown), a single camera could receive images through two different camera lenses to a common image sensor, such as a charge-coupled device (CCD). For instance, the single camera could be set up to operate at 60 Hertz (or other value). On odd cycles the single camera can receive an image of the user's eye and on even cycles the single camera can receive an image of what is in front of the user (e.g., the direction the user is looking). This configuration could accomplish the described functionality with fewer cameras.

As introduced above, complementary augmented reality system 1000 can have complementary augmented reality component (CARC) 1042. In some implementations, the CARC of device 1002 can perform processing on the environment data (e.g., spatial mapping data, etc.). Briefly, processing can include performing spatial mapping, employing various image analysis techniques, calibrating elements of the complementary augmented reality system, and/or rendering computer-generated content (e.g., complementary images), among other types of processing. Examples of components/engines with capabilities to accomplish at least some of the present concepts include Unity 5 game engine (Microsoft Corporation) and KinectFusion (Microsoft Corporation), among others.

In some implementations, CARC 1042 can include various modules. In the example shown in FIG. 10, as introduced above, the CARC includes scene calibrating module (SCM) 1044 and scene rendering module (SRM) 1046. Briefly, the SCM can calibrate various elements (e.g., devices) of complementary augmented reality system 1000 such that information collected by the various elements and/or images displayed by the various elements is appropriately synchronized. The SRM can render computer-generated content for complementary augmented reality experiences, such as rendering complementary images. For example, the SRM can render the computer-generated content such that images complement (e.g., augment) other computer-generated content and/or real world elements. The SRM can also render the computer-generated content such that images are appropriately constructed for a viewpoint of a particular user (e.g., view-dependent).

SCM 1044 can calibrate the various elements of the complementary augmented reality system 1000 to ensure that multiple components of the system are operating together. For example, the SCM can calibrate projector 1004 with respect to camera 1006 (e.g., a color camera, a depth camera, etc.). In one instance, the SCM can use an automatic calibration to project Gray code sequences to establish dense correspondences between the color camera and the projector. In this instance, room geometry and appearance can be captured and used for view-dependent projection mapping. Alternatively or additionally, the SCM can employ a live depth camera feed to drive projections over a changing room geometry.

In another example, SCM 1044 can calibrate multiple sensors 1038 with each other. For instance, the SCM can calibrate the outward-facing cameras 1008 with respect to camera 1006 by imaging a same known calibration pattern. In one case, the known calibration pattern can be designed onto device 1002. In this case the known calibration pattern can consist of a right-angle bracket with three retro-reflective markers (not shown) rigidly mounted on device 1002 and easily detected via cameras 1006 and/or 1008. Alternatively or additionally, device 1002 could be tracked using a room-installed tracking system (not shown). In this example, a tracked reference frame can be achieved by imaging a known set of 3D markers (e.g., points) from cameras 1006 and/or 1008. The projector 1004 and cameras 1006 and/or 1008 can then be registered together in the tracked reference frame. Examples of multi-camera tracking systems with capabilities to accomplish at least some of the present concepts include Vicon and OptiTrack camera systems, among others. An example of an ultrasonic tracker with capabilities to accomplish at least some of the present concepts includes InterSense IS-900 (Thales Visionix, Inc). In yet another example, simple technologies, such as those found on smartphones, could be used to synchronize device 1002 and the projector. For instance, inertial measurement units (e.g., gyrometer, accelerometer, compass), proximity sensors, and/or communication channels (e.g., Bluetooth, Wi-Fi, cellular communication) on device 1002 could be used to perform a calibration with the projector.

In another example, SCM 1044 can measure distances between various elements of the complementary augmented reality system 1000. For instance, the SCM can measure offsets between the retro-reflective tracking markers (introduced above) and lens(es) 1012 of device 1002 to find a location of the lens(es). In some instances, the SCM can use measured offsets to determine a pose of device 1002. In some implementations, a device tracker mount can be tightly fitted to device 1002 to improve calibration accuracy (not shown).

In another example, SCM 1044 can determine an interpupillary distance for a user wearing device 1002. The interpupillary distance can help improve stereo images (e.g., stereo views) produced by system 1000. For example, the interpupillary distance can help fuse stereo images such that views of the stereo images correctly align with both projected computer-generated content and real world elements. In some cases, a pupillometer can be used to measure the interpupillary distance. For example, the pupillometer can be incorporated on device 1002 (not shown).

Any suitable calibration technique may be used without departing from the scope of this disclosure. Another way to think of calibration can include calibrating (e.g., coordinating) the content (e.g., subject matter, action, etc.) of images. In some implementations, SCM 1044 can calibrate content to augment/complement other computer-generated content and/or real world elements. For example, the SCM can use results from image analysis to analyze content for calibration. Image analysis can include optical character recognition (OCR), object recognition (or identification), face recognition, scene recognition, and/or GPS-to-location techniques, among others. Further, the SCM can employ multiple instances of image analysis techniques. For example, the SCM could employ two or more face recognition image analysis techniques instead of just one. In some cases, the SCM can combine environment data from different sources for processing, such as from camera 1008 and projector 1048 and also from camera 1006 and projector 1004.

Furthermore, SCM 1044 can apply image analysis techniques to images/environment data in a serial or parallel manner. One configuration can be a pipeline configuration. In such a configuration, several image analysis techniques can be performed in a manner such that the image and output from one technique serve as input to a second technique to achieve results that the second technique cannot obtain operating on the image alone.

Scene rendering module (SRM) 1046 can render computer-generated content for complementary augmented reality. The computer-generated content (e.g., images) rendered by the SRM can be displayed by the various components of complementary augmented reality system 1000. For example, the SRM can render computer-generated content for projector 1004 and/or device 1002, among others. The SRM can render computer-generated content in a static or dynamic manner. For example, in some cases the SRM can automatically generate content in reaction to environment data gathered by sensors 1038. In some cases, the SRM can generate content based on pre-programming (e.g., for a computer game). In still other cases, the SRM can generate content based on any combination automatic generation, pre-programming, or other generation techniques.

Various non-limiting examples of generation of computer-generated content by SRM 1046 will now be described. In some implementations, the SRM can render computer-generated content for a precise viewpoint and orientation of device 1002, as well as a geometry of an environment of a user, so that the content appears correct for a perspective of the user. In one example, computer-generated content rendered from a viewpoint of the user can include virtual objects and effects associated with real geometry (e.g., existing real objects in the environment). The computer-generated content rendered from the viewpoint of the user view can be rendered into an off-screen texture. Another rendering can be performed on-screen. The on-screen rendering can be rendered from the viewpoint of projector 1004. In the on-screen rendering, geometry of the real objects can be included in the rendering. In some cases, color presented on the geometry of the real objects can be computed via a lookup into the off-screen texture. In some cases, multiple rendering passes can be implemented as general processing unit (GPU) shaders.

In some cases, the SRM can render content for projector 1004 or device 1002 that changes a surface appearance of objects in the environment. For instance, the SRM can use a surface shading model. A surface shading model can include projecting onto an existing surface to change an appearance of the existing surface, rather than projecting a new virtual geometry on top of the existing surface. In the example of chair 104 shown in FIG. 1, the SRM can render content that makes the chair appear as if it were upholstered in leather, when the chair actually has a fabric covering in the real world. In this example, the leather appearance is not a view-dependent effect; the leather appearance can be viewed by various people in the environment/room. In another instance, the SRM can render content that masks (e.g., hides) part of the chair such that the chair does not show through table image 200 (see FIG. 2).

In some cases, SRM 1046 can render a computer-generated 3D object for display by projector 1004 so that the 3D object appears correct given an arbitrary user's viewpoint. In this case, “correct” can refer to proper scale, proportions, placement in the environment, and/or any other consideration for making the 3D object appear more realistic to the arbitrary user. For example, the SRM can employ a multi-pass rendering process. For instance, in a first pass, the SRM can render the 3D object and the real world physical geometry in an off-screen buffer. In a second pass (e.g., projection mapping process), the SRM can combine the result of the first pass with surface geometry from a perspective of the projector using a projective texturing procedure, rendering the physical geometry. In some cases, the second pass can be implemented by the SRM as a set of custom shaders operating on real-world geometry and/or on real-time depth geometry captured by sensors 1038.

In the example multi-pass rendering process described above, SRM 1046 can render a view from the perspective of the arbitrary user twice in the first pass: once for a wide field of view (FOV) periphery and once for an inset area which corresponds to a relatively narrow FOV of device 1002. In the second pass, the SRM can combine both off-screen textures into a final composited image (e.g., where the textures overlap).

In some instances of the example multi-pass rendering process described above, SRM 1046 can render a scene five times for each frame. For example, the five renderings can include: twice for device 1002 (once for each eye, displayed by device 1002), once for the projected periphery from the perspective of the user (off-screen), once for the projected inset from the perspective of the user (off-screen), and once for the projection mapping and compositing step for the perspective of the projector 1004 (displayed by the projector). This multi-pass process can enable the SRM, and/or CARC 1042, to have control over what content will be presented in which view (e.g., by which device of system 1000).

SRM 1046 can render content for display by different combinations of devices in system 1000. For example, the SRM can render content for combined display by device 1002 and projector 1004. In one instance, the content for the combined display can be replicated content, i.e., the same content is displayed by both device 1002 and the projector. In other examples, the SRM can render an occlusion shadow and/or only render surface shaded content for display by the projector. In some cases, the SRM can only render content for display by the projector that is not view dependent. In some cases, the SRM can render stereo images for either public display (e.g., projection) or private display, or for a combination of public and private displays. Additionally or alternatively, the SRM can apply smooth transitions between the periphery and the inset.

In some cases, SRM 1046 can render content for projector 1004 as an assistive modality to device 1002. The assistive modality can be in addition to extending a FOV of device 1002. For example, the SRM can render content for the projector that adds brightness to a scene, highlights a specific object, or acts as a dynamic light source to provide occlusion shadows for content displayed by device 1002. In another example of the assistive modality, the content rendered by the SRM for the projector can help avoid tracking lag or jitter in a display of device 1002. In this case, the SRM can render content only for display by the projector such that the projected display is bound to real-world surfaces and therefore is not view dependent (e.g., surface-shaded effects). The projected displays can appear relatively stable and persistent since both the projector and the environment are in static arrangement. In another case, the SRM can render projected displays for virtual shadows of 3D objects.

Conversely, SRM 1046 can render content for device 1002 as an assistive modality to projector 1004. For example, the SRM can render content for device 1002 such as stereo images of virtual objects. In this example, the stereo images can help the virtual objects appear spatially 3D rather than as “decals” projected on a wall. The stereo images can add more resolution and brightness to an area of focus. Content rendered by the SRM for device 1002 can allow a user wearing device 1002 to visualize objects that are out of a FOV of the projector, in a projector shadow, and/or when projection visibility is otherwise compromised.

In some cases, SRM 1046 can render content for device 1002 and projector 1004 that is different, but complementary content. For example, the SRM can render content for device 1002 that is private content (e.g., a user's cards in a Blackjack game). The private content is to be shown only in device 1002 to the user/wearer. Meanwhile, public content can be projected (e.g., a dealer's cards). Similar distinction could be made with other semantic and/or arbitrary rules. For example, the SRM could render large distant objects as projected content, and nearby objects for display in device 1002. In another example, the SRM could render only non-view dependent surface-shaded objects as projected content. In yet another example, the SRM could render content such that device 1002 acts as a “magic” lens into a projected space, offering additional information to the user/wearer.

In some cases, SRM 1046 could render content based on a concept that a user may be better able to comprehend a spatial nature of a perspectively projected virtual object if that object is placed close to a projection surface. In complementary augmented reality, the SRM can render objects for display by projector 1004 such that they appear close to real surfaces, helping achieve reduction of tracking lag and noise. Then once the objects are in mid-air or otherwise away from the real surface, the SRM can render the objects for display by device 1002.

In yet other cases, where relatively precise pixel alignment can be achieved, SRM 1046 can render complementary content for display by both device 1002 and projector 1004 to facilitate high-dynamic range virtual images.

Furthermore, SRM 1046 could render content that responds real-time in a physically realistic manner to people, furniture, and/or other objects in the display environment. Innumerous examples are envisioned, but not shown or described for sake of brevity. Briefly, examples could include flying objects, objects moving in and out of a displayed view of device 1002, a light originating from a computer-generated image that flashes onto both real objects and computer-generated images in an augmented reality environment, etc. In particular, computer games offer virtually endless possibilities for interaction of complementary augmented reality content. Furthermore, audio could also be affected by events occurring in complementary augmented reality. For example, a computer-generated object image could hit a real world object and the SRM could cause a corresponding thump to be heard.

In some implementations, as mentioned above, complementary augmented reality system 1000 can be considered a stand-alone system. Stated another way, device 1002 can be considered self-sufficient. In this case, device 1002 could include various cameras, projectors, and processing capability for accomplishing complementary augmented reality concepts. The stand-alone system can be relatively mobile, allowing a user/wearer to experience complementary augmented reality while moving from one environment to another. However, limitations of the stand-alone system could include battery life. In contrast to the stand-alone system, a distributed complementary augmented reality system may be less constrained by power needs. An example of a relatively distributed complementary augmented reality system is provided below relative to FIG. 11.

FIG. 11 illustrates a second example complementary augmented reality system 1100. In FIG. 11, eight example device implementations are illustrated. The example devices include device 1102 (e.g., a computer or entertainment console) and device 1104 (e.g., a wearable device). The example devices also include device 1106 (e.g., a 3D sensor), which can have cameras 1108. The example devices also include device 1110 (e.g., a projector), device 1112 (e.g., remote cloud based resources), device 1114 (e.g., a smart phone), device 1116 (e.g., a fixed display), and/or device 1118 (e.g., a game controller), among others.

In some implementations, any of the devices shown in FIG. 11 can have similar configurations and/or components as introduced above for device 1002 of FIG. 10. Various example device configurations and/or components are shown on FIG. 11 but not designated for a particular device, generally indicating that any of the devices of FIG. 11 may have the example device configurations and/or components. Briefly, configuration 1120(1) represents an operating system centric configuration and configuration 1120(2) represents a system on a chip configuration. Configuration 1120(1) is organized into one or more applications 1122, operating system 1124, and hardware 1126. Configuration 1120(2) is organized into shared resources 1128, dedicated resources 1130, and an interface 1132 there between.

In either configuration, the example devices of FIG. 11 can include a processor 1134, storage 1136, sensors 1138, a communication component 1140, and/or a complementary augmented reality component (CARC) 1142. In some implementations, the CARC can include a scene calibrating module (SCM) 1144 and/or a scene rendering module (SRM) 1146, among other types of modules. In this example, sensors 1138 can include camera(s) and/or projector(s) among other components. From one perspective, any of the example devices of FIG. 11 can be a computer.

In FIG. 11, the various devices can communicate with each other via various wired or wireless technologies generally represented by lightning bolts 1007. Although in this example communication is only illustrated between device 1102 and each of the other devices, in other implementations some or all of the various example devices may communicate with each other. Communication can be accomplished via instances of communication component 1140 on the various devices, through various wired and/or wireless networks and combinations thereof. For example, the devices can be connected via the Internet as well as various private networks, LAN, Bluetooth, Wi-Fi, and/or portions thereof that connect any of the devices shown in FIG.

Some or all of the various example devices shown in FIG. can operate cooperatively to perform the present concepts. Example implementations of the various devices operating cooperatively will now be described. In some implementations, device 1102 can be considered a computer and/or entertainment console. For example, in some cases, device 1102 can generally control the complementary augmented reality system 1100. Examples of a computer or entertainment console with capabilities to accomplish at least some of the present concepts include an Xbox® (Microsoft Corporation) brand entertainment console and a Windows®/Linux/Android/iOS based computer, among others.

In some implementations, CARC 1142 on any of the devices of FIG. 11 can be relatively robust and accomplish complementary augmented reality concepts relatively independently. In other implementations the CARC on any of the devices could send or receive complementary augmented reality information from other devices to accomplish complementary augmented reality concepts in a distributed arrangement. For example, an instance of SCM 1144 on device 1104 could send results to CARC 1142 on device 1102. In this example, SRM 1146 on device 1102 could use the SCM results from device 1104 to render complementary augmented reality content. In another example, much of the processing associated with CARC 1142 could be accomplished by remote cloud based resources, device 1112.

As mentioned above, in some implementations device 1102 can generally control the complementary augmented reality system 1100. In one example, centralizing processing on device 1102 can decrease resource usage by associated devices, such as device 1104. A benefit of relatively centralized processing on device 1102 may therefore be lower battery use for the associated devices. In some cases, less robust associated devices may contribute to a more economical overall system.

An amount and type of processing (e.g., local versus distributed processing) of the complementary augmented reality system 1100 that occurs on any of the devices can depend on resources of a given implementation. For instance, processing resources, storage resources, power resources, and/or available bandwidth of the associated devices can be considered when determining how and where to process aspects of complementary augmented reality.

As noted above, device 1118 of FIG. 11 can be a game controller-type device. In the example of system 1100, device 1118 can allow the user to have control over complementary augmented reality elements (e.g., characters, sports equipment, etc.) in a game or other complementary augmented reality experience. Examples of controllers with capabilities to accomplish at least some of the present concepts include an Xbox Controller (Microsoft Corporation) and a PlayStation Controller (Sony Corporation).

Additional complementary augmented reality scenarios involving the example devices of FIG. 11 will now be presented. Device 1114 (e.g., a smart phone) and device 1116 (e.g., a fixed display) of FIG. 11 can be examples of additional displays involved in complementary augmented reality. Device 1104 can have a display 1148. Stated another way, device 1104 can display an image to a user that is wearing device 1104. Similarly, device 1114 can have a display 1150 and device 1116 can have a display 1152. In this example, device 1114 can be considered a personal device. Device 1114 can show complementary augmented reality images to a user associated with device 1114. For example, the user can hold up device 1114 while standing in an environment (not shown). In this case, display 1150 can show images to the user that complement real world elements in the environment and/or computer-generated content that may be projected into the environment.

Further, device 1116 can be considered a shared device. As such, device 1116 can show complementary augmented reality images to multiple people. For example, device 1116 can be a conference room flat screen that shows complementary augmented reality images to the multiple people (not shown). In this example, any of the multiple people can have a personal device, such as device 1104 and/or device 1114 that can operate cooperatively with the conference room flat screen. In one instance, the display 1152 can show a shared calendar to the multiple people. One of the people can hold up their smart phone (e.g., device 1114) in front of display 1152 to see private calendar items on display 1150. In this case, the private content on display 1150 can complement and/or augment the shared calendar on display 1152. As such, complementary augmented reality concepts can expand a user's FOV from display 1150 on the smart phone to include display 1152.

In another example scenario involving the devices of FIG. 11, a user can be viewing content on display 1150 of device 1114 (not shown). The user can also be wearing device 1104. In this example, complementary augmented reality projections seen by the user on display 1148 can add peripheral images to the display 1150 of the smart phone device 1114. Stated another way, the HMD device 1104 can expand a FOV of a complementary augmented reality experience for the user.

A variety of system configurations and components can be used to accomplish complementary augmented reality concepts. Complementary augmented reality systems can be relatively self-sufficient, as shown in the example in FIG. 10. Complementary augmented reality systems can be relatively distributed, as shown in the example in FIG. 11. In one example, an HMD device can be combined with a projection-based display to achieve complementary augmented reality concepts. The combined display can include 3D images, can be spatially registered in a real world scene, can be capable of a relatively wide FOV (>100 degrees) for a user, and can have view dependent graphics. The combined display can also have extended brightness and color, as well as combinations of public and private displays of data. Example techniques for accomplishing complementary augmented reality concepts are introduced above and will be discussed in more detail below.

### METHODS

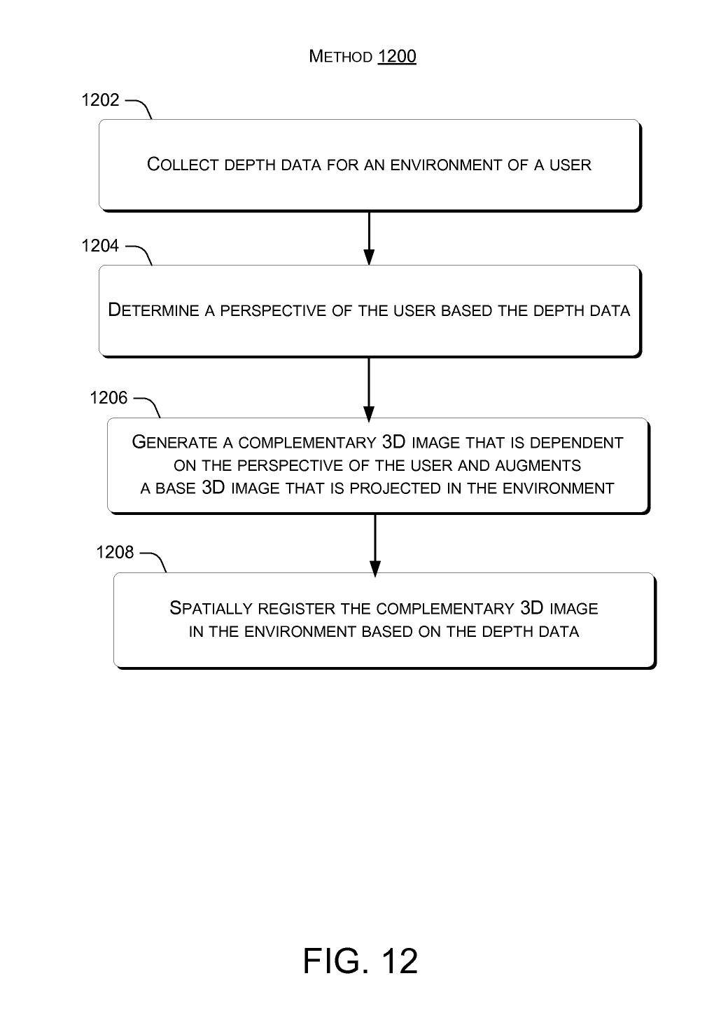

FIGS. 12-14 collectively illustrate example techniques or methods for complementary augmented reality. In some implementations, the example methods can be performed by a complementary augmented reality component (CARC), such as CARC 1042 and/or CARC 1142 (see FIGS. 10 and 11). Alternatively, the methods could be performed by other devices and/or systems.

FIG. 12 illustrates a first flowchart of an example method 1200 for complementary augmented reality. At block 1202, the method can collect depth data for an environment of a user.

At block 1204, the method can determine a perspective of the user based on the depth data.

At block 1206, the method can generate a complementary 3D image that is dependent on the perspective of the user and augments a base 3D image that is projected in the environment. In some cases, the method can use image data related to the base 3D image to generate the complementary 3D image.

At block 1208, the method can spatially register the complementary 3D image in the environment based on the depth data. In some cases, the method can generate the base 3D image and spatially register the base 3D image in the environment based on the depth data. In some implementations, the method can display the complementary 3D image such that the complementary 3D image partially overlaps the base 3D image. The method can display the complementary 3D image to the user such that the projected base 3D image expands a field of view for the user.

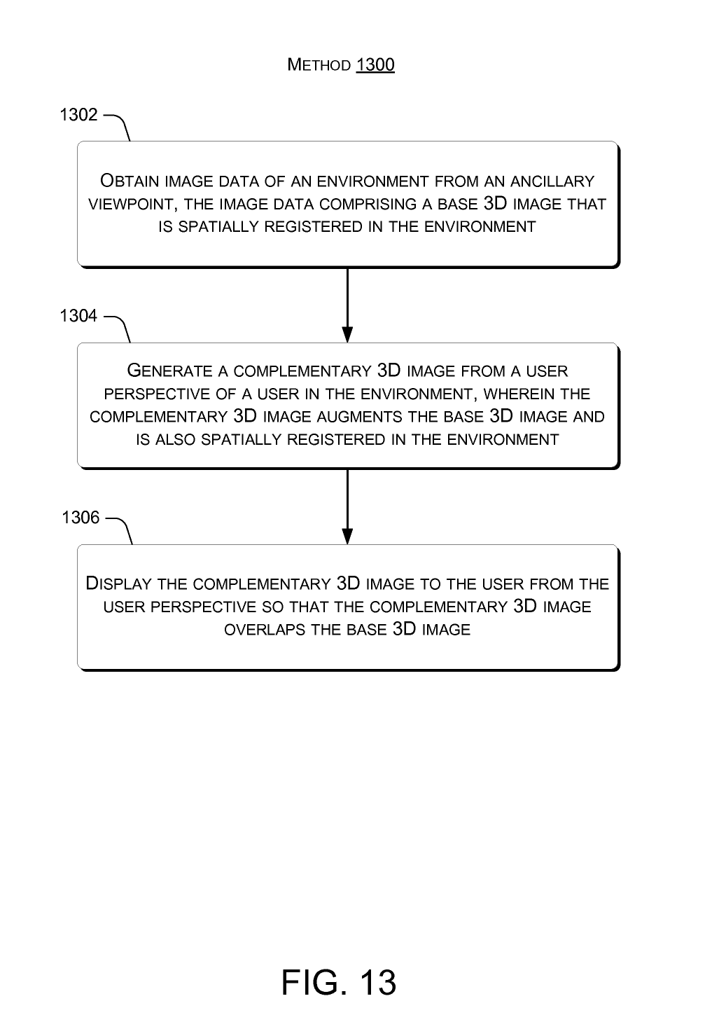

FIG. 13 illustrates a second flowchart of an example method 1300 for complementary augmented reality. At block 1302, the method can obtain image data of an environment from an ancillary viewpoint, the image data comprising a base 3D image that is spatially registered in the environment. In some cases, the method can project the base 3D image in the environment such that the base 3D image represents a field of view that is greater than 100 degrees as seen from a user perspective of a user in the environment.

At block 1304, the method can generate a complementary 3D image from the user perspective of the user in the environment, wherein the complementary 3D image augments the base 3D image and is also spatially registered in the environment.

At block 1306, the method can display the complementary 3D image to the user from the user perspective so that the complementary 3D image overlaps the base 3D image.

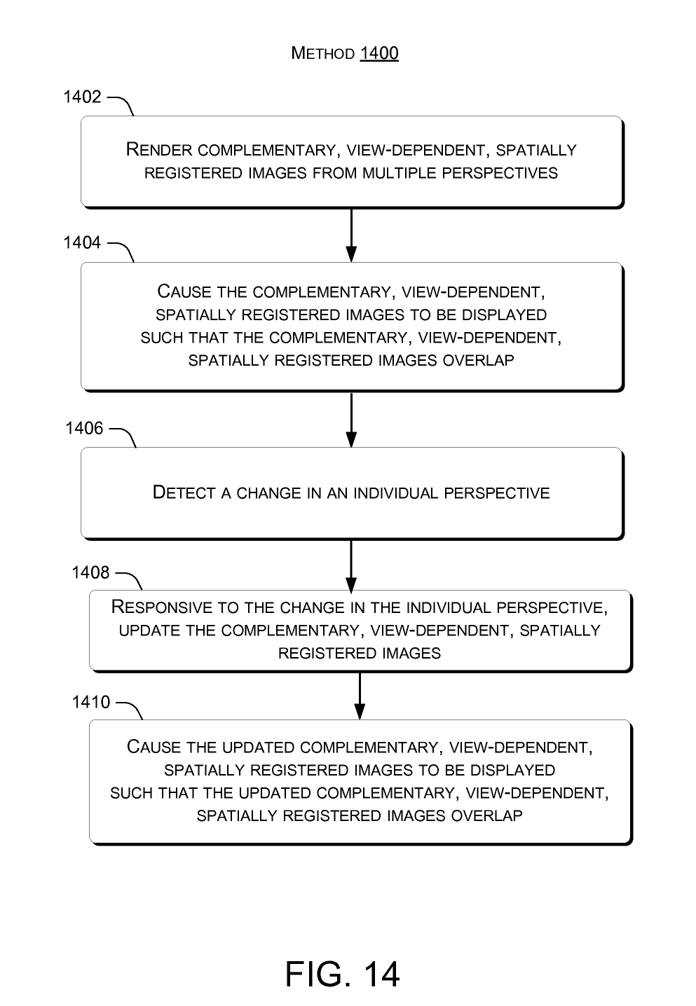

FIG. 14 illustrates a third flowchart of an example method 1400 for complementary augmented reality. At block 1402, the method can render complementary, view-dependent, spatially registered images from multiple perspectives. In some cases, the complementary, view-dependent, spatially registered images can be 3D images.

At block 1404, the method can cause the complementary, view-dependent, spatially registered images to be displayed such that the complementary, view-dependent, spatially registered images overlap.

At block 1406, the method can detect a change in an individual perspective. At block 1408, responsive to the change in the individual perspective, the method can update the complementary, view-dependent, spatially registered images.

At block 1410, the method can cause the updated complementary, view-dependent, spatially registered images to be displayed such that the updated complementary, view-dependent, spatially registered images overlap.

### Additional Examples

Example implementations are described above. Additional examples are described below. One example can include a projector configured to project a base image from an ancillary viewpoint into an environment. The example can also include a camera configured to provide spatial mapping data for the environment and a display configured to display a complementary 3D image to a user in the environment. The example can further include a processor configured to generate the complementary 3D image based on the spatial mapping data and the base image so that the complementary 3D image augments the base image and is dependent on a perspective of the user. In this example, the perspective of the user can be different than the ancillary viewpoint. The processor can be further configured to update the complementary 3D image as the perspective of the user in the environment changes.

Another example includes any of the above and/or below examples further comprising a console that is separate from the projector and the display, and where the console includes the processor.

Another example includes any of the above and/or below examples further comprising another display configured to display another complementary 3D image to another user in the environment. The processor is further configured to generate the another complementary 3D image that augments the base image and is dependent on another perspective of the another user.

Another example includes any of the above and/or below examples where the processor is further configured to determine the perspective of the user from the spatial mapping data.

Another example can include a projector configured to project a base image from a viewpoint into an environment. The example can also include a display device configured to display a complementary image that augments the base image. The complementary image can be dependent on a perspective of a user in the environment.

Another example includes any of the above and/or below examples further comprising a depth camera configured to provide spatial mapping data for the environment.

Another example includes any of the above and/or below examples where the depth camera comprises multiple calibrated depth cameras.

Another example includes any of the above and/or below examples where the viewpoint is an ancillary viewpoint and is different than the perspective of the user.

Another example includes any of the above and/or below examples where the base image is a 2D image and the complementary image is a 2D image, or where the base image is a 2D image and the complementary image is a 3D image, or where the base image is a 3D image and the complementary image is a 2D image, or where the base image is a 3D image and the complementary image is a 3D image.

Another example includes any of the above and/or below examples further comprising a processor configured to generate the complementary image based on image data from the base image and spatial mapping data of the environment.

Another example includes any of the above and/or below examples where the viewpoint does not change with time and the processor is further configured to update the complementary image as the perspective of the user changes with time.

Another example includes any of the above and/or below examples where the system further comprises additional projectors configured to project additional images from additional viewpoints into the environment.

Another example includes any of the above and/or below examples further comprising another display device configured to display another complementary image that augments the base image and is dependent on another perspective of another user in the environment.

Another example includes any of the above and/or below examples where the complementary image is comprised of stereo images.

Another example includes any of the above and/or below examples where the display device is further configured to display the complementary image within a first field of view of the user. The projector is further configured to project the base image such that a combination of the base image and the complementary image represents a second field of view of the user that is expanded as compared to the first field of view.

Another example includes any of the above and/or below examples where the first field of view comprises a first angle that is less than 100 degrees and the second field of view comprises a second angle that is greater than 100 degrees.

Another example can include a depth camera configured to collect depth data for an environment of a user. The example can further include a complementary augmented reality component configured to determine a perspective of the user based on the depth data and to generate a complementary 3D image that is dependent on the perspective of the user, where the complementary 3D image augments a base 3D image that is projected in the environment. The complementary augmented reality component is further configured to spatially register the complementary 3D image in the environment based on the depth data.

Another example includes any of the above and/or below examples further comprising a projector configured to project the base 3D image, or where the device does not include the projector and the device receives image data related to the base 3D image from the projector and the complementary augmented reality component is further configured to use the image data to generate the complementary 3D image.

Another example includes any of the above and/or below examples where the complementary augmented reality component is further configured to generate the base 3D image and to spatially register the base 3D image in the environment based on the depth data.

Another example includes any of the above and/or below examples further comprising a display configured to display the complementary 3D image such that the complementary 3D image partially overlaps the base 3D image.

Another example includes any of the above and/or below examples further comprising a head-mounted display device that comprises an optically see-through display configured to display the complementary 3D image to the user.

Another example includes any of the above and/or below examples further comprising a display configured to display the complementary 3D image to the user, where the display has a relatively narrow field of view, and where the projected base 3D image expands the relatively narrow field of view associated with the display to a relatively wide field of view.

Another example includes any of the above and/or below examples where the relatively narrow field of view corresponds to an angle that is less than 100 degrees and the relatively wide field of view corresponds to another angle that is more than 100 degrees.

Another example can obtain image data of an environment from an ancillary viewpoint, the image data comprising a base three-dimensional (3D) image that is spatially registered in the environment. The example can generate a complementary 3D image from a user perspective of a user in the environment, where the complementary 3D image augments the base 3D image and is also spatially registered in the environment. The example can also display the complementary 3D image to the user from the user perspective so that the complementary 3D image overlaps the base 3D image.

Another example includes any of the above and/or below examples where the example can further project the base 3D image in the environment such that the base 3D image represents a field of view that is greater than 100 degrees as seen from the user perspective.

Another example can render complementary, view-dependent, spatially registered images from multiple perspectives, causing the complementary, view-dependent, spatially registered images to be displayed such that the complementary, view-dependent, spatially registered images overlap. The example can detect a change in an individual perspective and can update the complementary, view-dependent, spatially registered images responsive to the change in the individual perspective. The example can further cause the updated complementary, view-dependent, spatially registered images to be displayed such that the updated complementary, view-dependent, spatially registered images overlap.

Another example includes any of the above and/or below examples where the complementary, view-dependent, spatially registered images are three-dimensional images.

Another example can include a communication component configured to obtain a location and a pose of a display device in an environment from the display device. The example can further include a scene calibrating module configured to determine a perspective of a user in the environment based on the location and the pose of the display device. The example can also include a scene rendering module configured to generate a base three-dimensional (3D) image that is spatially registered in the environment and to generate a complementary 3D image that augments the base 3D image and is dependent on the perspective of the user. The communication component can be further configured to send the base 3D image to a projector for projection and to send the complementary 3D image to the display device for display to the user.

Another example includes any of the above and/or below examples where the example is manifest on a single device, and where the single device is an entertainment console.

### CONCLUSION

The order in which the disclosed methods are described is not intended to be construed as a limitation, and any number of the described blocks can be combined in any order to implement the method, or an alternate method. Furthermore, the methods can be implemented in any suitable hardware, software, firmware, or combination thereof, such that a computing device can implement the method. In one case, the methods are stored on one or more computer-readable storage media as a set of instructions such that execution by a processor of a computing device causes the computing device to perform the method.

Although techniques, methods, devices, systems, etc., pertaining to complementary augmented reality are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a camera configured to provide spatial mapping data for an environment;
a projector configured to project a base three-dimensional (3D) image from an ancillary viewpoint into the environment, the base 3D image being spatially-registered in the environment based at least in part on the spatial mapping data;
a display configured to display a complementary 3D image to a user in the environment; and,
a processor configured to:
generate the complementary 3D image based at least in part on the spatial mapping data and the base 3D image so that the complementary 3D image augments the base 3D image and is dependent on a perspective of the user, wherein the perspective of the user is different than the ancillary viewpoint, and
update the complementary 3D image as the perspective of the user in the environment changes.

2. The system of claim 1, further comprising a console that is separate from the projector and the display, wherein the console includes the processor.

3. The system of claim 2, further comprising another display configured to display another complementary 3D image to another user in the environment, wherein the processor is further configured to generate the another complementary 3D image that augments the base 3D image and is dependent on another perspective of the another user.

4. The system of claim 1, wherein the processor is further configured to determine the perspective of the user from the spatial mapping data.

5. A system, comprising:
a projector configured to project a spatially-registered base three-dimensional (3D) image from a viewpoint into an environment; and,
a display device configured to display a complementary 3D image that augments the base 3D image, the complementary 3D image being dependent on a perspective of a user in the environment.

6. The system of claim 5, further comprising a depth camera configured to provide spatial mapping data for the environment.

7. The system of claim 6, wherein the depth camera comprises multiple calibrated depth cameras.

8. The system of claim 5, wherein the viewpoint is an ancillary viewpoint and is different than the perspective of the user.

9. The system of claim 5, wherein the display device receives image data related to the base 3D image from the projector and the display device uses the image data to generate the complementary 3D image.

10. The system of claim 5, further comprising a processor configured to generate the complementary 3D image based at least in part on image data from the base 3D image and spatial mapping data of the environment.

11. The system of claim 10, wherein the viewpoint does not change with time and the processor is further configured to update the complementary 3D image as the perspective of the user changes with time.

12. The system of claim 5, further comprising additional projectors configured to project additional images from additional viewpoints into the environment.

13. The system of claim 5, further comprising another display device configured to display another complementary 3D image that augments the base 3D image and is dependent on another perspective of another user in the environment.

14. The system of claim 5, wherein the complementary 3D image is comprised of stereo images.

15. The system of claim 5, wherein the display device is further configured to display the complementary 3D image within a first field of view of the user, and wherein the projector is further configured to project the base 3D image such that a combination of the base 3D image and the complementary 3D image represents a second field of view of the user that is expanded as compared to the first field of view.

16. The system of claim 15, wherein the first field of view comprises a first angle that is less than 100 degrees and the second field of view comprises a second angle that is greater than 100 degrees.

17. A device comprising:
a depth camera that collects depth data for an environment of a user; and,
a complementary augmented reality component that determines a perspective of the user based at least in part on the depth data and generates a complementary three-dimensional (3D) image that is dependent on the perspective of the user, wherein the complementary 3D image augments a base 3D image that is projected into and spatially-registered in the environment, and wherein the complementary augmented reality component spatially registers the complementary 3D image in the environment based at least in part on the depth data.

18. The device of claim 17, further comprising a projector that projects the base 3D image.

19. The device of claim 17, wherein the complementary augmented reality component generates the base 3D image and spatially registers the base 3D image in the environment based at least in part on the depth data.

20. The device of claim 17, further comprising a display that displays the complementary 3D image such that the complementary 3D image partially overlaps the base 3D image.
